(19) United States
(12) Patent Application Publication
(10) Pub. No.: US 2007/0146217 A1
(43) Pub. Date: Jun. 28, 2007

(54) Antenna and remote locking/unlocking system including such an antenna

(76) Inventor: Jean-Mathieu Stricker, Bischwiller (FR)

Correspondence Address: DELPHI TECHNOLOGIES, INC., M/C 480-410-202, PO BOX 5052, TROY, MI, 48007, US

(21) Appl. No.: 11/635,326

(22) Filed: Dec. 7, 2006

(30) Foreign Application Priority Data
Dec. 23, 2005 (EP) 05360056.5

(51) Int. Cl. H01Q 1/32

(52) U.S. Cl. 343/713; 343/702

(57) ABSTRACT

The invention relates to an antenna, of the type comprising an elongate conductive piece, intended for radio-communications, including a free end a base intended to be connected to a receiver and/or transmitter and at least one conductive track extending between the base and the free end and attached to a printed circuit support. The antenna includes two unconnected conductive tracks extending in the extension one of the other, and a metal structure attached to the printed circuit support and forming a bridge between the adjacent ends of the two conductive tracks, the metal structure at least partially extending projecting from the plane of extension of the support.

### TECHNICAL FIELD

The present invention relates to the general technical field of transmission and/or reception antennae used in particular in systems for locking/unlocking doors of a vehicle. These locking/unlocking systems are already known and allow the user to lock and unlock the doors of a vehicle remotely. These operations are generally performed by a receiver integrated in the vehicle and by a transmitter integrated for example in a key of the vehicle.

### BACKGROUND OF THE INVENTION

The present invention relates in particular to an antenna intended to be connected to a transmitter and/or receiver, thus forming a fixed antenna of a locking/unlocking system. Such an antenna captures an electromagnetic field and transforms it into an electrical signal transmitted to the receiver. The latter is advantageously mounted on a printed circuit support. The antenna is for example formed of a conductor wire through which high frequency currents flow. It consequently constitutes a transition device between the guided propagation medium, namely a supply line connected to a transmitter and/or a receiver, and a clear propagation space, in this case air. This transition must be performed with maximum efficiency. This supposes impedance adaptation between the antenna and the clear propagation space and, consequently, control of the antenna impedance.

The antenna impedance must also be as high as possible for its real part, for example between approximately 10 ohms and 100 ohms. The values of these impedances are indicative. The real part of the impedance reflects the radiation resistance, representative of the gain of the antenna transforming the electromagnetic field into electrical power and vice-versa. The reactive part of this same impedance must be as small as possible, and preferably neither inductive (+jX) nor capacitive (−jX). Now, in practice the impedance of the antenna often has a capacitive part, due to its small dimensions and/or due to its location in the vicinity of a plane of mass. The latter is defined by the grouping of the components and metallic tracks attached to the printed circuit support. The performance of the assembly comprising the antenna and a receiver or a transmitter may therefore not be optimal and the impedance adaptation not performed correctly.

The antenna in accordance with the invention operates in stationary wave regime, meaning that the distribution of the electric current is not uniform over its length. Stationary antennae are used in the frequency domain of the UHF band, centred around 434 MHz. The wavelength corresponding to such a frequency is approximately 70 cm.

The dimensions of a functional antenna are then linked to the frequency and consequently to the wavelength. In such a stationary wave regime, the antenna is comparable in principle to a quarter-wave line: this means that optimum performance is obtained with an antenna length equal to or approaching a quarter of the wavelength, which corresponds in the present case to approximately 17.5 cm. It is obviously impossible to integrate an antenna of such a length in a known locking/unlocking system. In fact, the bulk of such an antenna is too large, in particular to be embedded in a vehicle.

In order to reduce the bulk of the antenna without too greatly reducing its length, known antennae preferably extend in the plane of extension of the printed circuit support, in the vicinity of and along the plane of mass.

In this case, to increase the radiation of the antenna, that is to say its efficiency, it is desirable to reduce the density of the field lines between the antenna and the plane of mass. Now, this density is increased due to the dielectric nature of the printed circuit support separating the plane of mass from the antenna, and on the other hand by the location of this in the plane of the support.

Current antennae are of the type including at least one conductive track attached to a printed circuit support, with a free end and a base intended to be connected to a receiver and/or transmitter.

In practice, the conductive track forming the antenna forms part of the printed circuit and can be created by any known process, for example by silk-screen printing. In known configurations, and in order that the printed circuit support should not have too large dimensions, the whole of the antenna is placed in the proximity of the plane of mass, giving rise to the disadvantages mentioned.

This is also the case with configurations in which, in order to remedy the problem of conduction losses, the conductive track is doubled on opposite faces of the printed circuit support. The conductive tracks are then for example joined every 5 to 10 mm by metallized holes, and are located substantially at the same distance from the plane of mass.

Known locking/unlocking systems therefore have disadvantages resulting in reduced efficiency and reliability, in particular when the user wishing to activate or deactivate the locking/unlocking system is not in the immediate proximity of the said vehicle.

Locking/unlocking systems are activated and deactivated by means of a radio wave remote control which, for known systems, has a relatively limited range. The range is generally not greater than a radius of approximately 6 metres around the vehicle. Now, increasingly large numbers of vehicle manufacturers are requiring a maximum range of at least 20 metres around the vehicle, so as to obtain 100% operational reliability of the system within a radius of 6 metres, whatever the environment of the vehicle. The latter may for example be surrounded by other vehicles, trees, buildings, or other obstacles having a negative influence on the transmission of radio waves.

One improvement which can be envisaged would be to use higher performance electronic components in the receiver circuit. The use of such components would however have the consequence of increasing the energy consumption of the locking/unlocking system on standby, which is obviously not to be desired, in addition to increasing direct costs associated with the use of higher performance components.

The radio signal transmitted by the remote control is propagated by reflection and diffraction through the openings in the vehicle formed by the windows, to reach a reception antenna located for example behind the steering-wheel. Such a location of the reception antenna inside the vehicle substantially reduces the maximum range of the remote control compared with a reception antenna not confined inside the vehicle.

Propagation through windows is also attenuated by their structure: they are currently often a thermal and to this end include metallization attenuating the radio signal passing through them.

One solution consists of increasing the power of the transmitter arranged in the user's key. This is not advisable, as such a power increase involves an increase in bulk, which conflicts with the small space available in such a key for housing the transmitter and a suitable electrical supply battery. Moreover, the power increase of such a transmitter has the consequence of increasing the electrical energy consumption and consequently the frequency of battery replacement.

The range of a remote control device for locking and unlocking doors also depends on the link budget between the transmitter and receiver. The link budget involves the complete chain from the transmitter to the receiver. This budget takes into account the power of the transmitter and the sensitivity of the receiver and also the losses and gains of each element of the chain including the antenna.

For the transmitter, the power is limited by the low voltage technology (3 to 6 volts), the energy autonomy of the power supply battery and the current which this can deliver. Thus, the small dimensions of the transmitter, most frequently of the size of a key, limit the efficiency of the transmission antenna. The link budget also depends on the position of the transmitting key, on the terrain, on the propagation environment and on the structure of the vehicle. Lastly, the size of the vehicle windows, the material forming the said windows (for example in their athermal version) and the position of the receiver in a vehicle also influence this budget.

The sensitivity of the pair formed by the antenna and the receiver depends on the efficiency of the antenna and on the technology of the receiver (of integrated circuit type). This technology has limitations associated with constraints in energy consumption which must be as small as possible.

It is possible to insert a low-noise amplification stage between the antenna and a reception circuit, but to the detriment of energy consumption.

The amplification stage also risks causing interference to certain frequencies. The amplification stage must optimally have a transfer function F between its input signal and its output signal which is linear. Now, in practice the amplification stage degrades linearity performance at the input of the receiver. Linearity errors result in second and/or third degree polynomials expressing the said transfer function F. These polynomials generate interfering frequencies which can interfere with the nominal channel of the receiver, i.e. the usual transmission/reception operating frequency of the antenna. This interference effect is a determining parameter for the receiver, as it is detrimental to the overall performance of the receiver.

It is therefore difficult to substantially increase the range of a remote vehicle locking/unlocking system without negatively influencing a certain number of parameters and causing a negative effect on efficiency or an increase in the costs of such a system.

### SUMMARY OF THE INVENTION

The aim of the present invention is to increase the overall reliability and efficiency of a system for remote locking/unlocking by radio communication, principally by increasing its maximum range.

The aim is for example to obtain a maximum range greater than 20 m, and theoretically perfect operation within a radius of 6 m around the said vehicle, while not producing the additional disadvantages mentioned above, for example.

In accordance with the invention, to fulfil these aims, the antenna includes at least one conductive track attached to a printed circuit support, extending between a base intended to be connected to a receiver and/or transmitter and a free end, and it is principally characterised by the fact that it comprises:
two unconnected conductive tracks extending in the extension one of the other,
and a metal structure attached to the printed circuit support and forming a bridge between the proximal ends of the two conductive tracks, the metal structure extending at least partially projecting from the plane of extension of the support.

This extension, which is for example at right angles relative to the support, allows the antenna length to be increased, and thus more closely approach a quarter of the wavelength. It also favours excitation by other directional components of the electromagnetic field of the radio communications. Lastly, this solution distances at least a portion of the antenna from the printed circuit support and from the plane of mass. The efficiency of the antenna is therefore improved, as the density of the field lines between the plane of mass and the metal structure is lower for this portion than that existing between the plane of mass and the conductive tracks.

The antenna of the invention then functions much better both in transmission mode and in reception mode. In transmission mode, it becomes conceivable to transfer data from the vehicle to a remote control carried by the user. Moreover, the antenna can easily pass from transmission mode to reception mode in a determined frequency.

In accordance with one possibility, the two conductive tracks have substantially the same length. The metal structure is then arranged approximately in the centre of the antenna, which position allows maximum profit to be gained from its efficiency. The metal structure is then in fact positioned where the current distribution in the antenna is highest.

It can be formed of a rigid conductive strip, which in this case can be attached to the printed circuit support in automated manner to form the connection between the two adjacent conductive tracks. A stiffening element can additionally be fixed onto the metal structure in order to improve the automation.

The conductive strip can for example have a width of between 1 and 10 mm and thickness of between 0.2 and 1 mm.

In accordance with an example configuration, the metal structure can be U-shaped, including two legs the free ends of which are connected to the tracks.

The stiffening element can then for example consist of a cross-piece, for example made of synthetic material, connecting the two legs of the U-shape to which legs it is fixed by fixing studs. An arm for automated assembly or positioning can thus easily grip the said cross-piece and position the metal structure precisely on the printed circuit support, in order to fix it.

In accordance with an example embodiment, the antenna can have a top capacity at its free end. This top capacity gives the antenna characteristics obtained in principle with a longer antenna. The length of the antenna is thus virtually increased without substantially increasing its bulk.

Moreover, the antenna can also include an inductance located at its base, which also improves its performance. The base inductance again allows the length of the antenna to be virtually increased without substantially increasing its bulk. More precisely the use of a base inductance allows on the one hand the current flowing at the base of the antenna to be increased and on the other the addition of an inductive component (+jx) to the impedance of the antenna.

This inductive component (+jx) permits partial compensation for the intrinsic capacitive component (−jx) of the antenna impedance, and therefore improvement in the impedance adaptation between the antenna and the input impedance of the receiver and/or the transmitter.

Of course, the antenna can simultaneously include a base inductance and a top capacity.

The invention also relates to a receiver or a transceiver provided with such an antenna. Lastly, it covers a system for remote locking/unlocking of the doors of a vehicle comprising a mobile transmitter device carried by the user of the vehicle and a fixed receiver associated with an antenna such as described above, the said fixed receiver being arranged inside the vehicle.

Alternatively the invention also relates to a system for remote locking/unlocking of the doors of a vehicle comprising a mobile transceiver device carried by the user of the vehicle and a fixed transceiver associated with such an antenna, the said fixed transceiver being arranged inside the vehicle.

In addition to locking/unlocking, by means of the invention the user can benefit from a more efficient function to search for and locate his vehicle in a crowded environment such as a car-park.

### BRIEF DESCRIPTION OF THE DRAWINGS

Other characteristics and advantages of the invention will also become apparent from the following detailed description, with reference to the attached drawings, in which:

FIG. 1 is a diagrammatic perspective view of an example embodiment of an antenna in accordance with the invention;

FIGS. 2, 3, 4 and 5 show diagrammatically example embodiments of a receiver associated with an antenna in accordance with the invention;

FIG. 6 is an example embodiment of the integration of an antenna in accordance with the invention on a printed circuit support.

### DESCRIPTION OF THE PREFERRED AND ALTERNATIVE EMBODIMENT

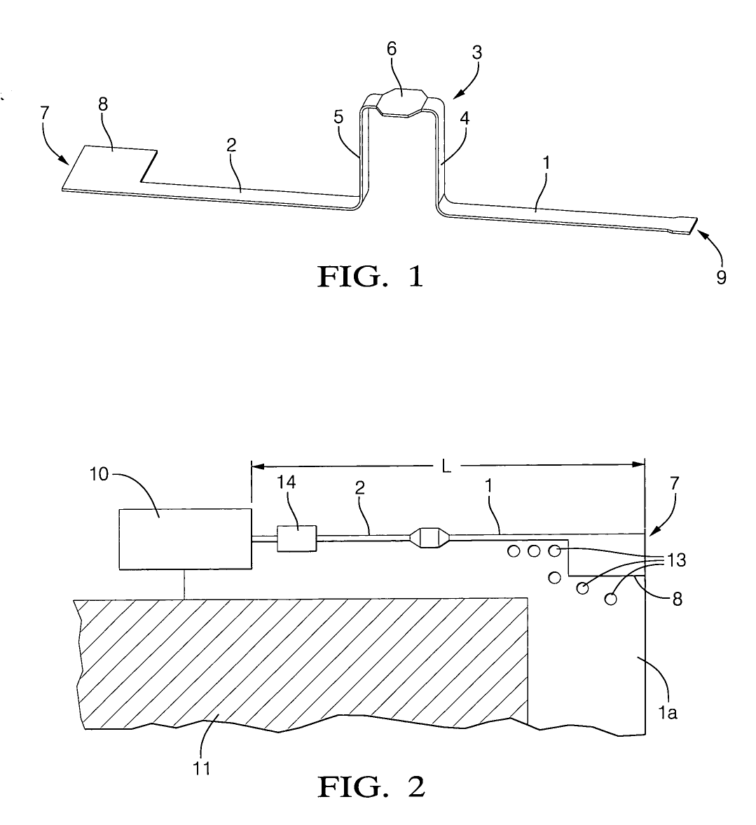

FIG. 1 shows an antenna in accordance with the invention. The antenna includes two conductive tracks 1 and 2 attached for example by screen-printing to a printed circuit support. The tracks 1, 2 have a copper thickness of between 15 and 80 μm and the dielectric constant of the printed circuit support is for example between 3 and 10.

In accordance with an example embodiment not shown, the conductive tracks 1, 2 can where necessary each be arranged on one of the faces of a printed circuit support and connected by metallized holes every 5 mm.

In addition, the antenna of the invention includes a metal structure 3 connecting the two conductive tracks 1 and 2, in fact forming a bridge between these. The metal structure 3 is for example U-shaped, having two lateral legs 4 and 5 and a central arm or back 6. Rigid conductive strips are used, having for example a width slightly greater than that of the tracks 1, 2 to facilitate possible handling of the U by an automated positioning arm.

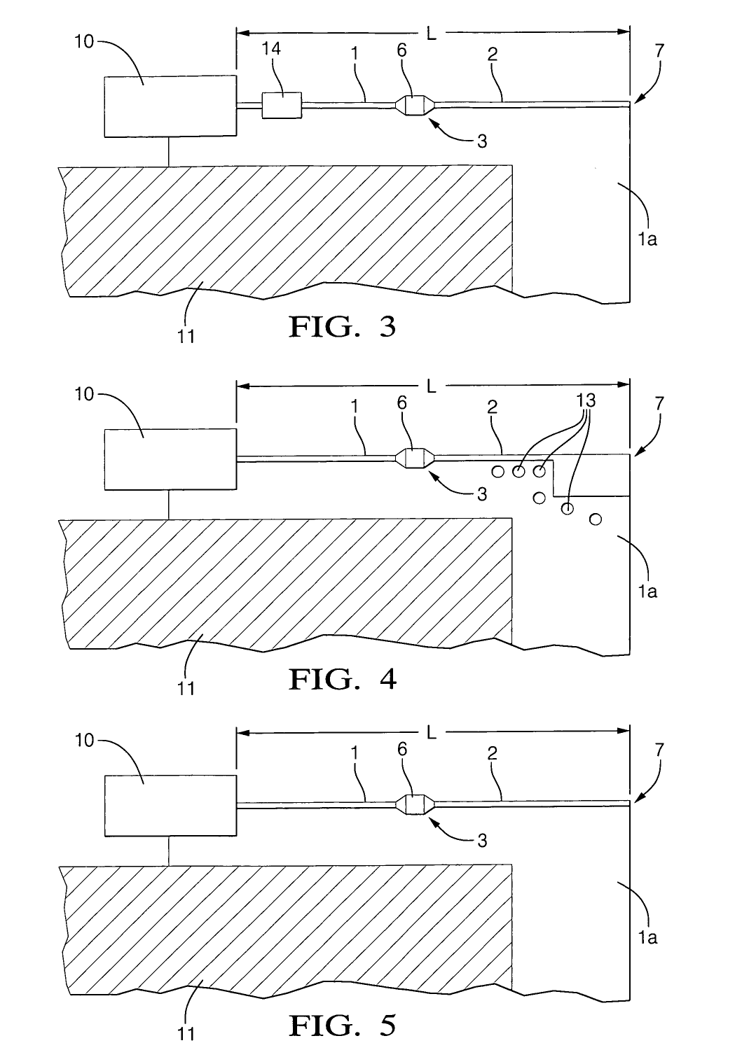

The antenna shown in FIGS. 2 and 4 has, at its free end 7, a charge capacity 8. This is formed of a substantially rectangular coppered surface approximately 1.5 cm long and 1 cm wide. This charge capacity 8, attached to the support 1a, partially compensates for the small dimensions of the antenna, improving its performance without increasing its length, by increasing the electric current at the base of the antenna on the one hand and the real part of its impedance on the other. The deficit in length of the antenna relative to a quarter of the wavelength is thus partially made good.

The other end 9 of the conductive track 1 is intended to be connected for example to a receiver 10. This end 9 thus constitutes the base of the antenna.

FIG. 2, for example, shows a plane of mass 11 separated from the top capacity 8 in particular by the material forming the support 1a. The latter has dielectric characteristics of a nature to increase the density of the field lines between the antenna, and in particular the top capacity 8, and the plane of mass 11, thus reducing the effectiveness and efficiency of the antenna.

In order to overcome this problem, holes 13 having a diameter of between 3 and 4 mm have been formed in the support 1a around the top capacity 8, and more generally around the last third of the antenna length. An improvement of approximately 10 to 15% in its range is thus obtained.

Due to the improvements made, the overall length L of the antenna can, in each illustrated example embodiment, be less than a quarter of the wavelength resulting from the frequency employed.

A further improvement to the antenna can consist of adding to its base 9 an inductance 14 at the point or in the vicinity of the point of connection to the receiver 10. This inductance 14 also improves the performance of the antenna in accordance with the invention, without increasing its length and/or its bulk.

In fact, the metal structure 3 increases the distance between a part of the antenna and the plane of mass 11 on the one hand and increases the length of the antenna on the other. It extends in a plane perpendicular to the plane of the support 1a, and practically doubles the range between the mobile transmitter and the fixed receiver positioned in the vehicle.

The example embodiment shown in FIGS. 2 and 3 emphasizes and verifies the real contribution of the metal structure 3, which leads to a reduction in the value of the inductance 14 at the base of the antenna (this changes for example from 39 nH to 27 nH). This reduction results from a modification in the distribution of the electric current in the antenna, and more precisely an increase in the current at the base of the antenna. Measurement of the impedance of the antenna shows that the real part of the impedance has practically doubled due to the use of the metal structure 3. FIGS. 4 and 5 show alternative configurations of the invention.

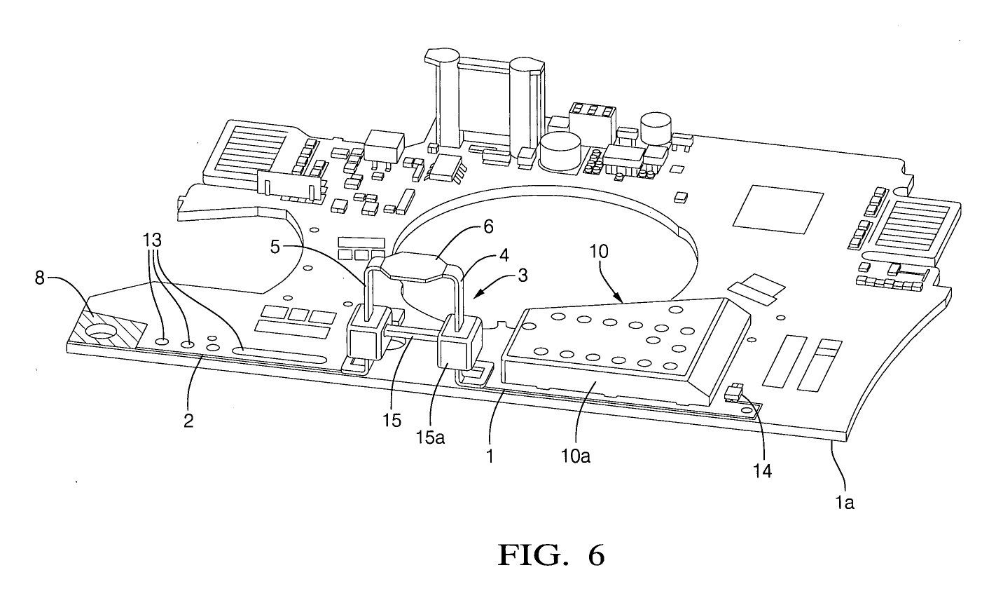

FIG. 6 shows a printed circuit support 1a to which various components have been attached and in particular an antenna in accordance with the invention. In this case the receiver is surrounded by a metal protective cage 10a.

In this figure, the metal structure 3 includes a stiffening arm 15 made of synthetic material. At its ends this has fixing studs 15a for insertion of the legs 4 and 5 of the metal structure 3. The metal structure 3 is then sufficiently stiff to be handled, displaced and positioned on the support 1a by means of an automated arm. The metal structure 3 can thus be attached to the support 1a in the same way as various other electronic components embedded in the printed circuit. These components may or may not fulfil functions associated with the locking/unlocking system.

1. An antenna of the type comprising an elongate conductive piece, intended for radio-communications, including at least one conductive track attached to a printed circuit support, extending between a base intended to be connected to a receiver and/or transmitter and a free end, said antenna comprising:
two unconnected conductive tracks extending in the extension one of the other; and
a metal structure attached to the printed circuit support and forming a bridge between the proximal ends of the two conductive tracks, the metal structure extending at least partially projecting from the plane of extension of the support.

2. The antenna as described in the claim 1, wherein the two conductive tracks have substantially the same length.

3. The antenna as described in claim 1, wherein the metal structure is a rigid conductive strip.

4. The antenna as described in claim 1, further comprising a stiffening element fixed onto the metal structure.

5. The antenna as described in claim 1, wherein the metal structure has the shape of a U the free ends of the legs of which are connected to the tracks.

6. The antenna as described in claim 5, wherein a stiffening cross-piece is fixed via fixing studs to the legs.

7. The antenna as described in claim 1, further comprising a top capacity located at its free end.

8. The antenna as described in claim 1, further comprising an inductance located at its base.

9. A receiver connected to an antenna as described in claim 1.

10. A transceiver connected to an antenna as described in claim 1.

11. A system for remote locking/unlocking of the doors of a vehicle comprising a mobile transmitter device carried by the user of the vehicle and a receiver as described in claim 9, the said receiver being arranged inside the vehicle.

12. A system for remote locking/unlocking of the doors of a vehicle comprising a mobile transceiver device carried by the user of the vehicle and a fixed transceiver as described in claim 10, the said fixed transceiver being arranged inside the vehicle.
